(19) United States
(12) Patent Application Publication
(10) Pub. No.: US 2025/0172129 A1
(43) Pub. Date: May 29, 2025

(54) Configurable Components For Shape Memory Alloy (SMA) Actuators

(71) Applicant: Hutchinson Technology Incorporated, Hutchinson, MN (US)

(72) Inventor: Ryan N. Ruzicka, Waconia, MN (US)

(21) Appl. No.: 18/957,521

(22) Filed: Nov. 22, 2024

Related U.S. Application Data
(60) Provisional application No. 63/603,010, filed on Nov. 27, 2023.

(51) Int. Cl. F03G 7/06

(52) U.S. Cl. CPC F03G 7/06143; F03G 7/0665

(57) ABSTRACT

The present embodiments relate to shape memory alloy (SMA) actuator designs that can have a custom sized SMA wire length and/or a carriage specific to different systems (e.g., optical image stabilization systems, autofocus systems). The actuator can include a common base (or fixed end) and a common tip portion (or free end) that can be common across different SMA designs.

### CROSS-REFERENCE TO RELATED APPLICATION(S)

This application claims the benefit of, and priority to, U.S. Provisional Application No. 63/603,010 filed on Nov. 27, 2023, which is hereby incorporated by reference in its entirety.

### TECHNICAL FIELD

Embodiments of the invention relate to the field of shape memory alloy (SMA) systems. More particularly, embodiments of the invention relate to the field of shape memory alloy actuators with a variable carriage and SMA wire length.

### BACKGROUND

Shape memory alloy (“SMA”) systems can include an actuator or structure that can be used in conjunction with various components, such as a camera lens element as an auto-focusing drive or an optical image stabilization (OIS) drive. The SMA actuator can be configured to actuate responsive to providing an electrical current to the SMA wire.

For example, a first end of an SMA wire can be engaged at a fixed end fixed to a base. Further, a second end of the SMA wire can be engaged to a free end configured to move in response to the actuation of the SMA wire. For instance, the free end can move in a z-direction in response to the actuation of the SMA wire.

### SUMMARY

The present embodiments relate to shape memory alloy (SMA) actuator designs, sometimes referred to as a bimorph actuator or SMA bimorph actuator, that can have a custom sized SMA wire length and/or a carriage specific to different systems (e.g., optical image stabilization systems, autofocus systems). The actuator can include a common base (or fixed end) and a common tip portion (or free end) that can be common across different SMA designs.

In a first example embodiment, a shape memory alloy (SMA) actuator is provided. The SMA actuator can include a base configured to be fixed to a carriage, and a free end configured to be unfixed from the carriage. The SMA actuator can also include one or more SMA wires that are electrically connected at a first end to the base and at a second end to the free end. A length of the carriage and the one or more SMA wires can be variable and based on a system in which the SMA actuator is configured to be included.

In some instances, the SMA actuator comprises two SMA wires, and wherein the two SMA wires are disposed on an upper surface of the base and the free end that is directed opposite to the carriage.

In some instances, the base includes a first set of contact pads disposed on a first side of the base and second set of contact pads at a second side of the base, wherein the first and second sets of contact pads are configured to provide an electrical current to any of the at least two SMA wires and a trench that electrically isolates a first SMA wire from the second SMA wire.

In some instances, the trench comprises a first portion that is formed in the base between a first SMA wire of the two SMA wires and a second SMA wire of the two SMA wires, and wherein the trench comprises a second portion that extends toward the first side of the base or the second side of the base.

In some instances, the base comprises a mechanical shear protruding from either the first side of the base or the second side of the base.

In some instances, the two SMA wires are disposed on a lower surface of the base and the free end, wherein the lower surface comprising a surface that is directed towards the carriage.

In some instances, the base further comprises a set of connection portions extending from the base toward the free end, wherein the at least one SMA wire connects to the base at the first end at any of the set of connection portions.

In some instances, the free end further comprises a set of connection portions extending from the free end toward the base, wherein the at least one SMA wire connects to the base at the second end at any of the set of connection portions.

In some instances, one or more openings are formed in the carriage.

In some instances, the system comprises any of an optical image stabilization system or an autofocus system.

In another example embodiment, a base configured to be a fixed end of a shape memory alloy (SMA) actuator is provided. The base can include a set of contact portions comprising a first contact portion configured to connect to a first SMA wire and a second contact portion configured to connect to a second SMA wire. The base can also include a set of electrical contacts disposed on each of a first side and a second side of the base and configured to provide an electrical current to the SMA wires. The base can also include a trench disposed along the base and extending to either of the first side or second side of the base to electrically isolate the set of contact portions and the SMA wires.

In some instances, the base comprises a mechanical shear protruding from either the first side or the second side of the base.

In some instances, the trench comprises a first portion that is formed in the base between a first SMA wire of the two SMA wires and a second SMA wire of the two SMA wires, and wherein the trench comprises a second portion that extends toward the first side of the base or the second side of the base.

In some instances, the SMA wires are configured to be disposed on an upper surface or a lower surface of the base.

In some instances, the base further comprises a set of connection portions extending from the base toward a free end, wherein the SMA wires connect to the base at the first end at any of the set of connection portions.

In another example embodiment, a method is provided. The method can include providing a base portion and a free portion of a shape memory alloy (SMA) actuator, wherein the base portion is configured to be fixed to a carriage and the free portion is configured to be unfixed from the carriage. The method can also include etching a trench in the base portion to electrically isolate a first connection portion and a second connection portion of the base. The method can also include affixing a first end of a first SMA wire to the first connection portion of the base portion and affixing a second end of the first SMA wire to the free end.

In some instances, a length of the carriage and the first SMA wire is variable based on a system that the SMA actuator is implemented.

In some instances, the method can include affixing a first end of a second SMA wire to the second connection portion of the base portion and affixing a second end of the second SMA wire to the free end.

In some instances, the method can include removing a first mechanical shear protruding from a first side of the base portion, leaving a second mechanical shear protruding from a second side of the base portion.

In some instances, the first SMA wire is affixed to the first connection portion on an upper surface of the first connection portion comprising a surface opposing the carriage or a lower surface of the first connection portion comprising a surface facing the carriage.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates an example SMA actuator according to an embodiment.

FIG. 2 illustrates a set of example actuators with custom components according to an embodiment.

FIG. 3 illustrates a SMA actuator according to an embodiment.

FIGS. 4A-4B illustrate examples of the fixed end according to an embodiment.

FIG. 5 illustrates an actuator with a compliant base, a compliant tip, and SMA wires on an upper side of carriage according to an embodiment.

FIG. 6 illustrates a first example actuator with SMA wires disposed on a bottom surface of the base and tip comprising a surface facing the carriage according to an embodiment.

FIG. 7 illustrates a second example actuator with SMA wires disposed on a bottom surface of the base and tip comprising a surface facing the carriage according to an embodiment.

### DETAILED DESCRIPTION

In many cases, an actuator system can include a shape memory alloy (SMA) actuator. The SMA actuator can be configured to actuate in response to a current being applied to the SMA material. For instance, an actuator (also referred to as a bimorph actuator) as described herein can include a SMA material (e.g., SMA wire) affixed to a beam that allows for actuation in the Z-direction.

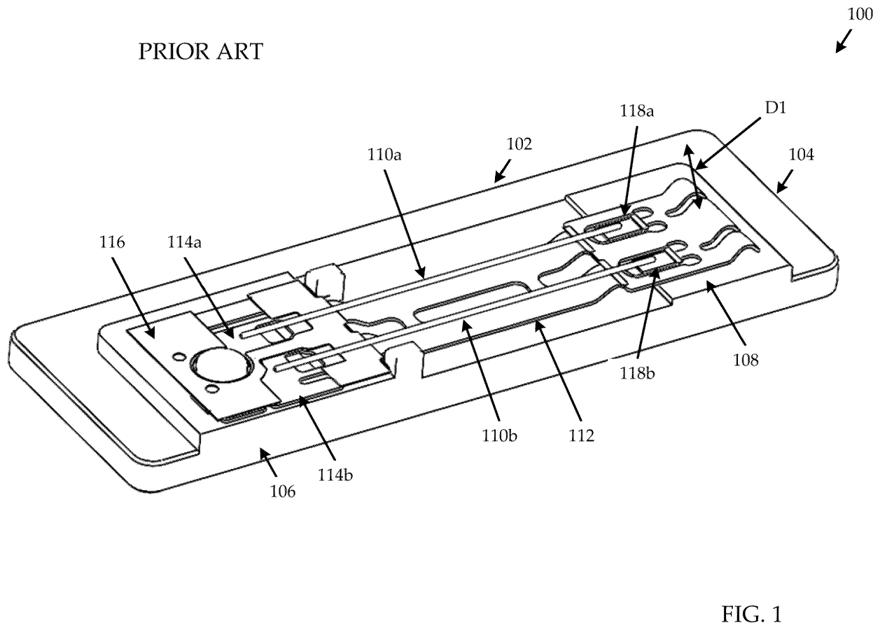

FIG. 1 illustrates an example prior art SMA actuator 100 according to some embodiments. As shown in FIG. 1, in many cases, the actuator 100 can include a carriage 104. In many instances, the actuator can be affixed to the carriage 104 as described herein. The carriage 104 can increase resiliency of the actuator 100 by providing support for the actuator.

The actuator 100 can include a fixed end 106 and a free end 108. The fixed end 106 can be fixed to the carriage 104, while the free end 108 can be detached from the carriage 104. As described in greater detail below, the free end 108 can move in a z-stroke direction (e.g., direction D1) responsive to providing an electrical current to SMA wires 110a, 110b.

As shown in FIG. 1, SMA wires 110a, 110b can extend from the fixed end 106 to the free end 108 of the actuator 100. Further, a beam 112 can be disposed below the SMA wires 110a, 110b and can connect the fixed end 106 and free end 108. The SMA wires 110a, 110b can connect to the actuator 100at each end via electrical contacts. For example, at a first end of each SMA wires 110a, 110b, the SMA wires 110a, 110b can connect to the fixed end 106 at electrical contacts 114a, 114b. Further, at a second end (e.g., at the free end 108), the SMA wires 110a, 110b can connect to the free end 108 at electrical contacts 118a, 118b (e.g., via a welding or soldering process).

The actuator 100 can consist of a material such as steel or stainless steel, for example. Further, electrical contacts 114a-b, 118a-b can include a material allowing for receiving a welding or soldering joint, such as a gold-plated stainless steel, for example. Further, at free end 106, a dielectric 116 can isolate the electrical contacts 114a-b to prevent electrical current between the contacts. Dielectric 116 can include insulative materials, such as a Polyimide, for example. In some embodiments, a dielectric can be disposed between SMA wires 110a-110b and beam 112 at the free end 108 to electrically isolate the SMA wires 110a-b from the beam 112.

In some instances, the actuator can include a three-layer design, with a first layer comprising stainless steel, a second layer comprising a polyimide (e.g., isolating electrical contacts, and a third layer comprising gold-plated stainless steel.

For instance, in the actuator 100 as shown in FIG. 1, the SMA 110a-b can be engaged to the base (e.g., at 114a-b, 118a-b) at a top or upper surface of the actuator (e.g., a surface facing away from the carriage 104). The SMA can be welded (or soldered) to a top stainless-steel surface (or, in some cases, a gold-plated metal). However, as described in greater detail below, such a configuration can result in lower resiliency of the weld joint due at least to the wire angle and maximum stress occurring at the weld joint as the SMA actuates.

As described with respect to FIG. 1, the actuator can include a fixed end, free end, and a carriage containing a limiter that allows for tip motion in the Z-direction D1. Further, the fixed end may have only one set of tail pads, so specific components may be required for the X/Y axis.

The present embodiments can include actuator designs that can have a custom sized SMA wire length and/or a carriage specific to different systems (e.g., optical image stabilization systems, autofocus systems). The actuator can include a common base (or fixed end) and a common tip portion (or free end) that can be common across different SMA designs.

Further, the actuators as described herein can have an improved performance with longer wire length (e.g., increased force, increased stroke margin, faster SMA wire heating/cooling, lower power consumption). The actuator can be adaptable to a module footprint while maintaining common components (common base and tip components, a custom carriage length). Further, the base and tip portion can be entirely metallic and not require a polyimide (e.g., supports 1L tip and 2L base). The actuator can also have a reversible orientation with redundant tail pad feature to enable commonality in different orientations.

In some instances, manufacturing actuators as described herein can include forming SMA wires of a desired length. The actuator metal can be etched, and the carriage can be manufactured using any of an injection molding process, machine plastic, or 3D printed plastic, for example.

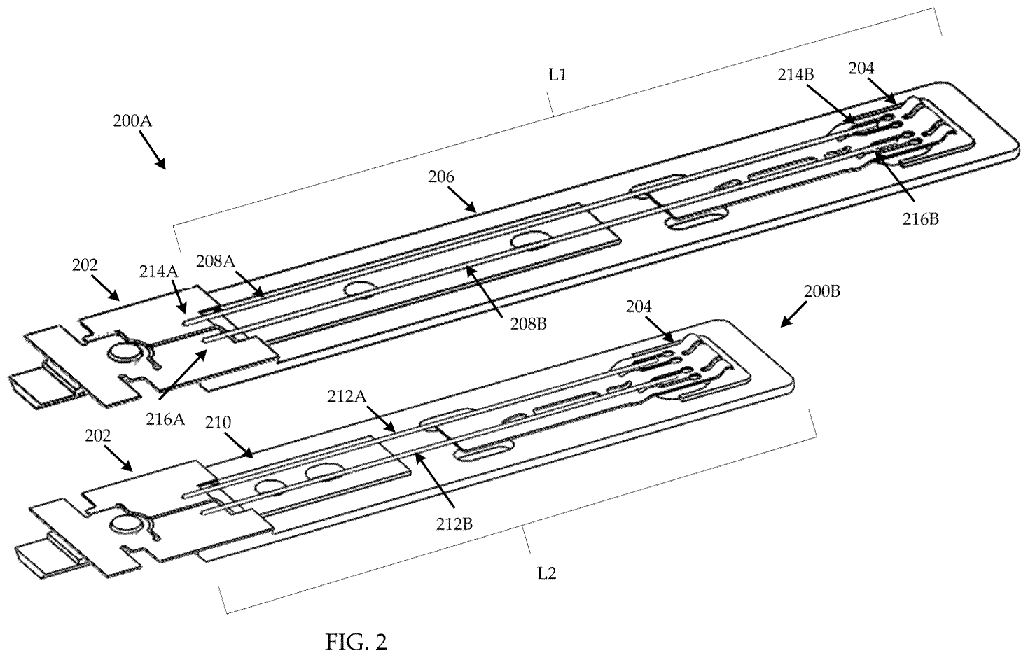

FIG. 2 illustrates a set of example actuators 200A-B with custom components. As shown in FIG. 2, a first actuator 200A can include a fixed end 202, free end 204, and a carriage 206 comprising a first length. SMA wires 208A-B can extend between the fixed end 202 and free end 204 and can include a length that corresponds with that of the carriage 206. Each SMA wire 208A, 208B can connect at a first end 214A, 216A to electric contact portions at the fixed end 202, and at a second end 216A, 216B to electric contact portions at the free end 204. The length L1 of the carriage in the first actuator 200A can differ from the length L2 of the carriage in the second actuator 200B.

The second actuator 200B can include a fixed end 202 and free end 204 that comprise dimensions similar to the fixed end 202 and free end as shown in first actuator 200A. However, the carriage 210 and SMA wires 212A can have a different length than carriage 206 and SMA wires 208A-B in the first actuator 200A. In some instances, the first actuator 200A can have a length of around 17 mm, and the second actuator 200B can have a length of around 13 mm, or a range of between 5-25 mm, for example.

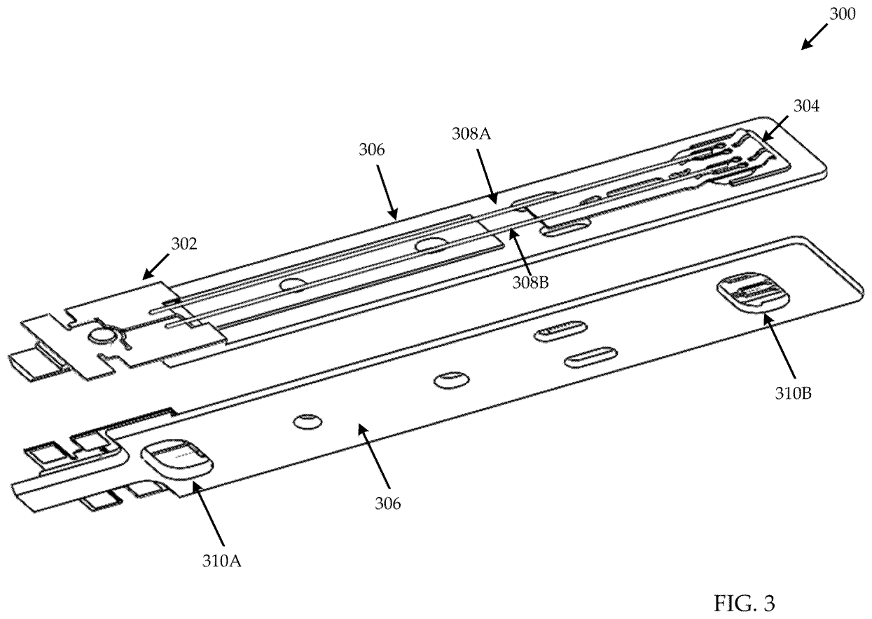

FIG. 3 illustrates a SMA actuator 300. As shown in FIG. 3, the actuator can include a fixed end 302, free end 304, carriage 306, and SMA wires 308A-B. The SMA wires 308A-B can be disposed on an upper side of the base 302 and tip 304 that comprises a side away from the carriage 306.

Further, as shown at a bottom side of the actuator 300, one or more openings 310A, 310B can be formed in the carriage. For instance, a first opening 310A can be formed under the fixed end 302 and a second opening 310B can be formed under the free end 304.

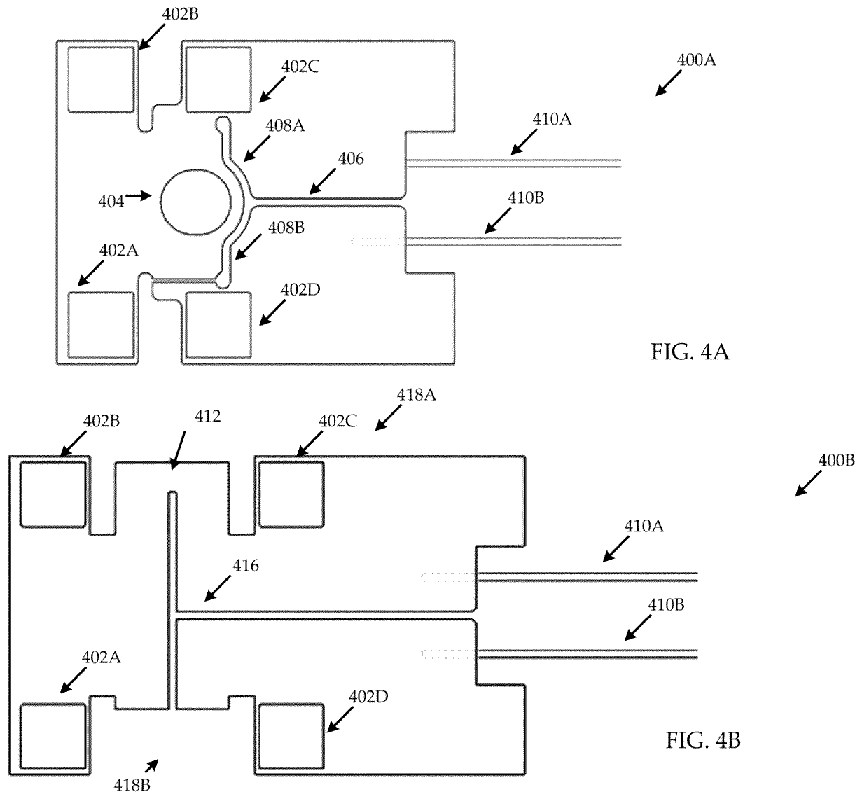

As described above, a fixed end of the actuator can include a reversible orientation that can allow for commonality of components etched or laser cut as part of a process to manufacture the actuator. FIGS. 4A-4B illustrate examples of the fixed end 400A, 400B. For instance, as shown in FIG. 4A, the fixed end 400A can include contact pads 402A-D for connecting to a power source and providing a current to the SMA wires 410A-B. A trench 406 can be disposed within the fixed end to provide an electrical isolation between SMA wires 410A-B. Further, the trench 406 includes sides 408A-B, where in the example in FIG. 4A, the trench extends along the second side 408B to electrically isolate SMA wires 410A-B. In some instances, the trench can include a first portion (e.g., 406) disposed between the SMA wires 410A, 410B. The trench can also include a second portion that extends towards the first side (e.g., trench portion 408A) or extending towards the second side (e.g., trench portion 408B).

The extension of the second side 408B can be done via a laser cutting process after assembly of the actuator to the carriage to maintain commonality of the trench. However, in a reversed orientation, the trench 406 can extend along the first side 408A. In some instances, an opening 404 can be disposed in the fixed end 400A to fit into a protrusion extending from a carriage.

The present actuators as described herein can allow for electricity to flow separately to contact pads for each SMA wire. The trench disposed in the actuators can be used as either a top or bottom side of the fixed end to allow for electrical isolation of the SMA wires.

As shown in FIG. 4B, the fixed end 400B can include a mechanical shear 412 in which electricity from pads 402A-D can flow to the SMA wires 410A-B. The fixed end 400B can include both a first end 418A and a second end 418B. While in FIG. 4B, an opposing end (or second end 418B) without a shear is provided, this orientation can be reversed, with a mechanical shear on the opposing end 418B. Further, a trench 416 can electrically isolate SMA wires 410A-B based on a location of the mechanical shear 412.

In some instances, the opposing end 418B in FIG. 4B may initially have a U-shaped element that is sheared off, isolating the pad 402D from other pads 402A-C. In such examples, electricity can be introduced at pad 402A to pad 402D after running through SMA wires 410A-B. In a reversed orientation, the U-shaped element can remain at second end 418B, while the mechanical shear 412 would be removed, isolating pad 402C.

As described above, the actuator as described herein can be manufactured with various component specifications. For instance, a fixed end and free end can be the same specification, but a carriage length, SMA wire length, and a location of the SMA wires can change for different contexts.

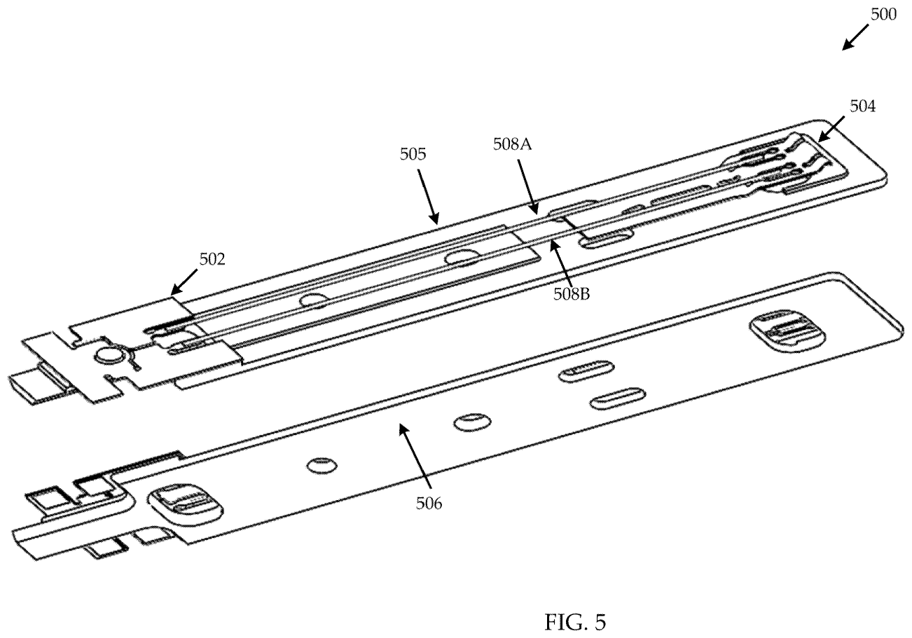

FIGS. 5-7 illustrate various SMA actuators 500, 600, 700 with different combinations of base, tip portion, and carriage components. FIG. 5 illustrates an actuator 500 with a compliant base 502, a compliant tip 504, and SMA wires 508A-B on an upper side of carriage 506.

The term “rigid” can refer to the fact that the connected ends of the wires move with the same degrees of freedom as the bulk base and tip regions and thus the wire can experience more bending at the connections and bending stress which is worse for reliability. The term “compliant” can relate to features that enable more bending flexibility in the metallic base and tip and thus less bending stress in the SMA wire.

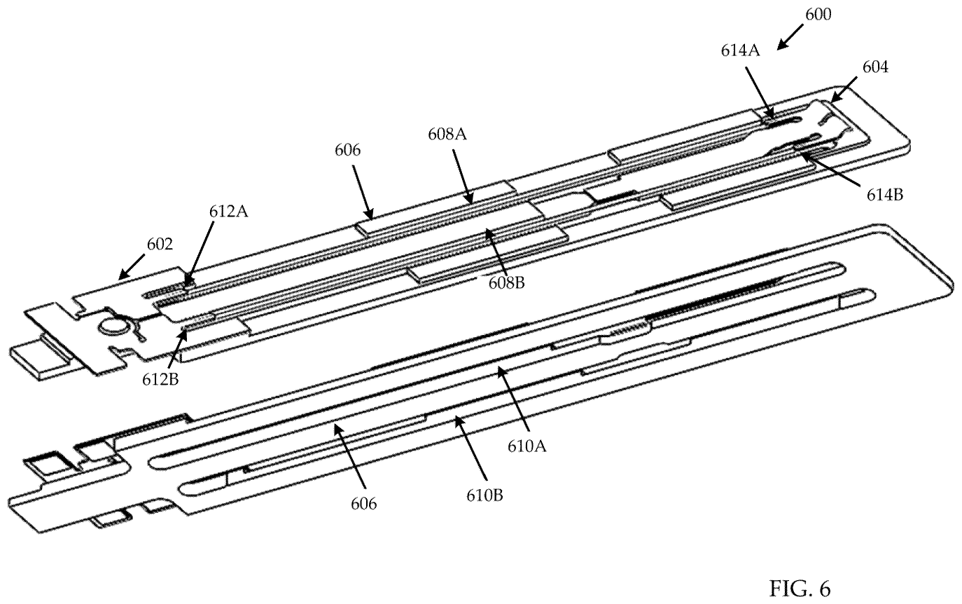

FIG. 6 illustrates an example actuator 600 with SMA wires 608A-B disposed on a bottom surface of the base 602 and free end 604 comprising a surface facing the carriage 606. The carriage 606 can include multiple openings 610A-B extending along the carriage 606 and being disposed substantially along a length of the SMA wires 608A-B. The base 602 can include connection portions 612A, 612B extending toward the free end 604. Further, the free end 604 can include connection portions 614A, 614B extending toward the base 602. The SMA wires 608A, 608B can connect at a first end to connection portions 612A, 612B at the base 602 and at a second end to the connection portions 614A, 614B at the free end 604.

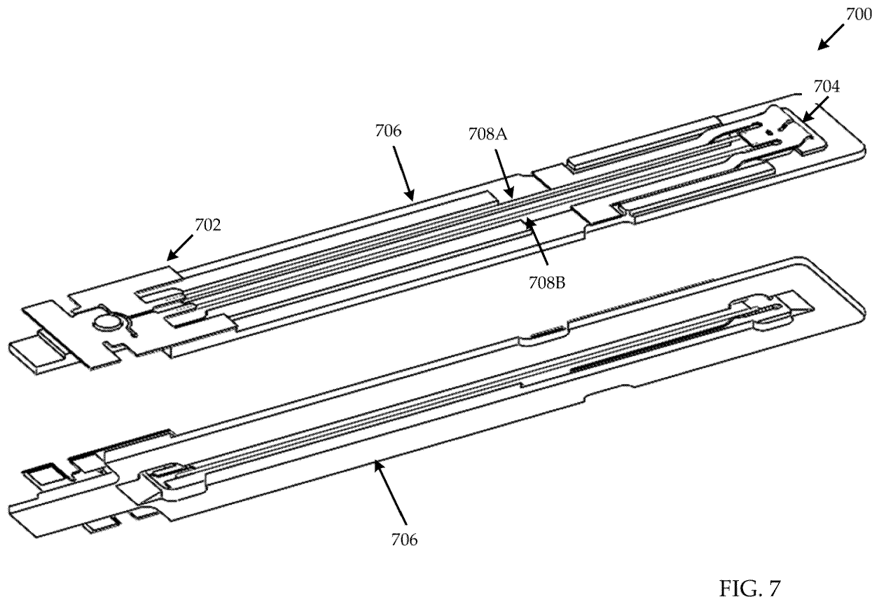

In FIG. 7, the actuator 700 can have SMA wires 708A-B disposed on a bottom surface of the base 702 and free end 704 comprising a surface facing the carriage 706. Further, the carriage 706 can include a single opening disposed along a length of the carriage 706.

In a first example embodiment, a shape memory alloy (SMA) actuator is provided. The SMA actuator can include a base (e.g., 202) configured to be fixed to a carriage (e.g., 206), and a free end (e.g., 204) configured to be unfixed from the carriage. The SMA actuator can also include one or more SMA wires (e.g., 208A, 208B) that are electrically connected at a first end to the base and at a second end to the free end. A length of the carriage and the one or more SMA wires can be variable and based on a system in which the SMA actuator is configured to be included.

In some instances, the SMA actuator comprises two SMA wires, and wherein the two SMA wires are disposed on an upper surface of the base and the free end that is directed opposite to the carriage.

In some instances, the base includes a first set of contact pads disposed on a first side of the base and second set of contact pads at a second side of the base, wherein the first and second sets of contact pads are configured to provide an electrical current to any of the at least two SMA wires and a trench that electrically isolates a first SMA wire from the second SMA wire.

In some instances, the trench comprises a first portion that is formed in the base between a first SMA wire of the two SMA wires and a second SMA wire of the two SMA wires, and wherein the trench comprises a second portion that extends toward the first side of the base or the second side of the base.

In some instances, the base comprises a mechanical shear protruding from either the first side of the base or the second side of the base.

In some instances, the two SMA wires are disposed on a lower surface of the base and the free end, wherein the lower surface comprising a surface that is directed towards the carriage.

In some instances, the base further comprises a set of connection portions extending from the base toward the free end, wherein the at least one SMA wire connects to the base at the first end at any of the set of connection portions.

In some instances, the free end further comprises a set of connection portions extending from the free end toward the base, wherein the at least one SMA wire connects to the base at the second end at any of the set of connection portions.

In some instances, one or more openings are formed in the carriage.

In some instances, the system comprises any of an optical image stabilization system or an autofocus system.

In another example embodiment, a base configured to be a fixed end of a shape memory alloy (SMA) actuator is provided. The base can include a set of contact portions comprising a first contact portion configured to connect to a first SMA wire and a second contact portion configured to connect to a second SMA wire. The base can also include a set of electrical contacts disposed on each of a first side and a second side of the base and configured to provide an electrical current to the SMA wires. The base can also include a trench disposed along the base and extending to either of the first side or second side of the base to electrically isolate the set of contact portions and the SMA wires.

In some instances, the base comprises a mechanical shear protruding from either the first side or the second side of the base.

In some instances, the trench comprises a first portion that is formed in the base between a first SMA wire of the two SMA wires and a second SMA wire of the two SMA wires, and wherein the trench comprises a second portion that extends toward the first side of the base or the second side of the base.

In some instances, the SMA wires are configured to be disposed on an upper surface or a lower surface of the base.

In some instances, the base further comprises a set of connection portions extending from the base toward a free end, wherein the SMA wires connect to the base at the first end at any of the set of connection portions.

In another example embodiment, a method is provided. The method can include providing a base portion and a free portion of a shape memory alloy (SMA) actuator, wherein the base portion is configured to be fixed to a carriage and the free portion is configured to be unfixed from the carriage. The method can also include etching a trench in the base portion to electrically isolate a first connection portion and a second connection portion of the base. The method can also include affixing a first end of a first SMA wire to the first connection portion of the base portion and affixing a second end of the first SMA wire to the free end.

In some instances, a length of the carriage and the first SMA wire is variable based on a system that the SMA actuator is implemented.

In some instances, the method can include affixing a first end of a second SMA wire to the second connection portion of the base portion and affixing a second end of the second SMA wire to the free end.

In some instances, the method can include removing a first mechanical shear protruding from a first side of the base portion, leaving a second mechanical shear protruding from a second side of the base portion.

In some instances, the first SMA wire is affixed to the first connection portion on an upper surface of the first connection portion comprising a surface opposing the carriage or a lower surface of the first connection portion comprising a surface facing the carriage.

It will be understood that terms such as “top,” “bottom,” “above,” “below,” and x- direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A shape memory alloy (SMA) actuator comprising:
a base configured to be fixed to a carriage;
a free end configured to be unfixed from the carriage; and
one or more SMA wires that are electrically connected at a first end to the base and at a second end to the free end, wherein a length of the carriage and the one or more SMA wires is variable and based on a system in which the SMA actuator is configured to be included.

2. The SMA actuator of claim 1, wherein the SMA actuator comprises two SMA wires, and wherein the two SMA wires are disposed on an upper surface of the base and the free end that is directed opposite to the carriage.

3. The SMA actuator of claim 2, wherein the base includes:
a first set of contact pads disposed on a first side of the base and second set of contact pads at a second side of the base, wherein the first and second sets of contact pads are configured to provide an electrical current to any of the at least two SMA wires; and
a trench that electrically isolates a first SMA wire from the second SMA wire.

4. The SMA actuator of claim 3, wherein the trench comprises a first portion that is formed in the base between a first SMA wire of the two SMA wires and a second SMA wire of the two SMA wires, and wherein the trench comprises a second portion that extends toward the first side of the base or the second side of the base.

5. The SMA actuator of claim 4, wherein the base comprises a mechanical shear protruding from either the first side of the base or the second side of the base.

6. The SMA actuator of claim 3, wherein the two SMA wires are disposed on a lower surface of the base and the free end, wherein the lower surface comprising a surface that is directed towards the carriage.

7. The SMA actuator of claim 6, wherein the base further comprises a set of connection portions extending from the base toward the free end, wherein the at least one SMA wire connects to the base at the first end at any of the set of connection portions.

8. The SMA actuator of claim 6, wherein the free end further comprises a set of connection portions extending from the free end toward the base, wherein the at least one SMA wire connects to the base at the second end at any of the set of connection portions.

9. The SMA actuator of claim 1, wherein one or more openings are formed in the carriage.

10. The SMA actuator of claim 1, wherein the system comprises any of an optical image stabilization system or an autofocus system.

11. A base configured to be a fixed end of a shape memory alloy (SMA) actuator, the base comprising:
a set of contact portions comprising a first contact portion configured to connect to a first SMA wire and a second contact portion configured to connect to a second SMA wire;
a set of electrical contacts disposed on each of a first side and a second side of the base and configured to provide an electrical current to the SMA wires; and
a trench disposed along the base and extending to either of the first side or second side of the base to electrically isolate the set of contact portions and the SMA wires.

12. The base of claim 11, wherein the base comprises a mechanical shear protruding from either the first side or the second side of the base.

13. The base of claim 11, wherein the trench comprises a first portion that is formed in the base between a first SMA wire of the two SMA wires and a second SMA wire of the two SMA wires, and wherein the trench comprises a second portion that extends toward the first side of the base or the second side of the base.

14. The base of claim 11, wherein the SMA wires are configured to be disposed on an upper surface or a lower surface of the base.

15. The base of claim 11, wherein the base further comprises a set of connection portions extending from the base toward a free end, wherein the SMA wires connect to the base at the first end at any of the set of connection portions.

16. A method comprising:
providing a base portion and a free portion of a shape memory alloy (SMA) actuator, wherein the base portion is configured to be fixed to a carriage and the free portion is configured to be unfixed from the carriage;
etching a trench in the base portion to electrically isolate a first connection portion and a second connection portion of the base; and
affixing a first end of a first SMA wire to the first connection portion of the base portion and affixing a second end of the first SMA wire to the free end.

17. The method of claim 16, wherein a length of the carriage and the first SMA wire is variable based on a system that the SMA actuator is implemented.

18. The method of claim 16, further comprising:
affixing a first end of a second SMA wire to the second connection portion of the base portion and affixing a second end of the second SMA wire to the free end.

19. The method of claim 16, further comprising:
removing a first mechanical shear protruding from a first side of the base portion, leaving a second mechanical shear protruding from a second side of the base portion.

20. The method of claim 16, wherein the first SMA wire is affixed to the first connection portion on an upper surface of the first connection portion comprising a surface opposing the carriage or a lower surface of the first connection portion comprising a surface facing the carriage.
